(19) United States
(12) Patent Application Publication
(10) Pub. No.: US 2022/0331762 A1
(43) Pub. Date: Oct. 20, 2022

(54) STIRRING PROCESS AND STIRRING SYSTEM FOR NEODYMIUM-IRON-BORON POWDER AND PROCESS FOR MANUFACTURING NEODYMIUM-IRON-BORON MAGNETIC STEEL

(71) Applicant: JL MAG RARE EARTH CO., LTD., Ganzhou (CN)

(72) Inventors: Huayun Mao, Ganzhou, Jiangxi (CN); Tiefu Zhou, Ganzhou (CN); Congyao Mao, Ganzhou, Jiangxi (CN); Xiaoping Jin, Ganzhou, Jiangxi (CN); Jian Liu, Ganzhou, Jiangxi (CN)

(73) Assignee: JL MAG RARE EARTH CO., LTD., Ganzhou (CN)

(21) Appl. No.: 17/639,930

(22) PCT Filed: Dec. 4, 2019
(86) PCT No.: PCT/CN2019/122865

§ 371 Date: Mar. 3, 2022

(30) Foreign Application Priority Data
Nov. 28, 2019 (CN) 201911189224.0

(51) Int. Cl. B01F 33/40; B22F 9/04; B01F 35/00; B01F 23/60; H01F 41/02; H01F 1/057

(52) U.S. Cl. CPC B01F 33/401; B22F 9/04; B01F 33/406; B01F 35/187; B01F 23/69; H01F 41/0253; H01F 1/0577; B22F 2009/044; B22F 2301/355; B01F 2101/26

(57) ABSTRACT

Disclosed are a stirring process and a stirring system for a neodymium-iron-boron powder and a process for manufacturing a neodymium-iron-boron magnetic steel. The stirring process for the neodymium-iron-boron powder mainly comprises the following aeration, feeding and stirring. Specifically, the aeration refers to filling a mixer with nitrogen and/or an inert gas, with the internal space of the mixer closed; the feeding refers to placing a neodymium-iron-boron powder to be stirred into the mixer and keeping the internal space of the mixer closed; and the stirring refers to introducing the mixer with a pulsed air stream, which is an intermittently jetted air stream formed by nitrogen and/or an inert gas, and by which the neodymium-iron-boron powder can be repeatedly blown up and down to mix and stir the neodymium-iron-boron powder.

The present application claims priority to Chinese Patent Application No. 201911189224.0, titled “STIRRING PROCESS AND STIRRING SYSTEM FOR NEODYMIUM-IRON-BORON POWDER AND PROCESS FOR MANUFACTURING NEODYMIUM-IRON-BORON MAGNETIC STEEL”, filed on Nov. 28, 2019 with the China National Intellectual Property Administration, which is incorporated herein by reference in its entirety.

### FIELD

The present disclosure relates to the technical field of production and manufacturing of neodymium-iron-boron, and in particular to a stirring process and a stirring system of neodymium-iron-boron powder, and a manufacturing process of neodymium-iron-boron magnetic steel.

### BACKGROUND

Sintered neodymium-iron-boron permanent magnets are widely used in new energy vehicles, electronic products and other fields due to the magnetic energy product and high coercivity. Especially in recent years, with the development of new energy vehicles and the development of electronic products, the market demand to the sintered permanent magnets is booming, and at the same time the requirements to its performance and quality become more strictly.

Sintered neodymium-iron-boron permanent magnets are prepared by smelting, powdering, pressing, sintering and the like. Regarding the process of powdering as the initial process, the quality of the powder plays a vital role in the performance of the magnet. In the typically industrial production of sintered neodymium-iron-boron, after jet milling, the uniformity of the powder composition, powder particle size, and powder particle shape is relatively poor. Among them, there are three nonuniformities: the first is nonuniform composition, in which the powder composition produced previously is different from that produced subsequently. The second is nonuniform powder particle size, in which the size of the powder particles produced previously is relative small and that produced subsequently is relative large. The third is nonuniform powder particle shape. These three kinds of nonuniformities apply an important influence on the uniformity and consistency of subsequent processes and magnet product quality. Therefore, it is necessary to carry out mixing treatment on the powder after being jet milling so that the composition, size, and particle shape of the powder body are uniform on the whole. In the existing industrial production, a three-dimensional mixer is generally used for mixing, but this method is heavy time consuming (generally more than two hours) and often incurs the situation of insufficient mixing.

### SUMMARY

In view of this, the present application is direct to provide a stirring process and a stirring system of neodymium-iron-boron powder, and a manufacturing process of neodymium-iron-boron magnetic steel, which can fully stir and mix the neodymium-iron-boron powder.

In order to achieve said objective, the following technical solutions are provided in the present disclosure.

Provided is a stirring process of neodymium-iron-boron powder, comprising the following steps:

inflation: filling nitrogen and/or inert gas inside a mixter, with internal space of the mixer being closed;

feeding: feeding neodymium-iron-boron powder to be stirred into the mixer and maintaining the internal space of the mixer closed;

stirring: inflating the mixer with a pulsed gas flow, which is a gas flow sprayed at intervals and formed by nitrogen and/or inert gas, wherein the pulsed gas flow can repeatedly blow up and down the neodymium-iron-boron powder so as to mix and stir the neodymium-iron-boron powder.

Preferably, in the above-mentioned stirring process of neodymium-iron-boron powder, the pulsed gas flow is provided by a nozzle arranged at the bottom of the mixer and a gas transmission pipeline connected with the nozzle.

Preferably, in the above-mentioned stirring process of neodymium-iron-boron powder, a continuous spray duration of the pulsed gas flow is between 0.2 and 0.4 seconds, a continuous suspend duration is greater than 1 second, and a spray pressure of the pulsed gas flow is between 0.7 Mpa and 0.8 Mpa.

Preferably, in the above-mentioned stirring process of neodymium-iron-boron powder, the nitrogen and/or inert gas used to form the pulsed gas flow enters the mixer after being cooled, the temperature of the nitrogen and/or inert gas before entering the mixer is between 15° C. and 25° C.

Preferably, the above-mentioned stirring process of neodymium-iron-boron powder further comprises the following steps:

separation and filtration: performing a gas-solid separation to the mixed gas flowing out of the mixer;

circulation: feeding the neodymium-iron-boron powder obtained by separation back to the mixer to continue to be mixed; sending the gas obtained by separation into the mixer to form a pulsed gas flow.

Provided is a manufacturing process of neodymium-iron-boron magnetic steel, comprising following steps:

smelting: mixing raw materials at a preset ratio and smelting to obtain massive alloy ingots or flake alloy ingots;

hydrogen crushing: feeding the massive alloy ingots or flake alloy ingots into a hydrogen crushing reactor to react with hydrogen to form neodymium-iron-boron coarse powder with larger particles; (larger particles refer that the neodymium-iron-boron coarse powder has larger particles than the neodymium-iron-boron fine powder mentioned below)

coarse powder stirring: feeding the neodymium-iron-boron coarse powder into a first mixer for mixing and stirring;

jet milling: further processing the neodymium-iron-boron coarse powder that has been subjected to coarse powder stirring using jet milling to form neodymium-iron-boron fine powder with smaller particles; (smaller particles refer that the neodymium-iron-boron fine powder has smaller particles than the neodymium-iron-boron coarse powder mentioned above)

fine powder stirring: feeding the neodymium-iron-boron fine powder into a second mixer for mixing and stirring, wherein the stirring process of the second mixer is the stirring process of neodymium-iron-boron powder according to any one of claims 1 to 5;

forming: making the neodymium-iron-boron fine powder that has been subjected to fine powder stirring into a block-shaped blank using a press and a mold; and

sintering: sintering the formed block-shaped blank to form neodymium-iron-boron magnetic steel in a sintering furnace.

Preferably, in the above-mentioned manufacturing process of neodymium-iron-boron magnetic steel, an additive is added to the second mixer during the process of fine powder stirring.

Preferably, in the above-mentioned manufacturing process of neodymium-iron-boron magnetic steel, the additive is a solid additive, and during the process of the fine powder stirring, the solid additive is added into the second mixer through an auxiliary material feeding port provided on the second mixer, and the solid additive is mixed with the neodymium-iron-boron fine powder.

Preferably, in the above-mentioned manufacturing process of neodymium-iron-boron magnetic steel, the additive is a liquid additive, and during the process of the fine powder stirring, the liquid additive is spayed into the second mixer after being atomized by the auxiliary material injector provided on the second mixer, and the liquid additive is mixed with the neodymium-iron-boron fine powder.

Preferably, in the above-mentioned manufacturing process of neodymium-iron-boron magnetic steel, the additive is a liquid additive,

a nozzle for forming a pulsed gas flow is provided at the bottom of the second mixer, which is externally connected with a gas transmission pipeline for transmission of nitrogen and/or inert gas, and

as the pulsed gas flow being sprayed, the liquid additive is added into the gas transmission pipeline, mixed with nitrogen and/or inert gas, and then sprayed into the second mixer through the nozzle.

Preferably, in the above-mentioned manufacturing process of neodymium-iron-boron magnetic steel, an ultra-fine powder is obtained by separating the neodymium-iron-boron fine powder formed by jet milling through a separator, and the ultra-fine powder is added to the second mixer, and mixed and stirred with the neodymium-iron-boron fine powder, wherein the ultra-fine powder has an average particle size of less than 2 microns.

Preferably, in the above-mentioned manufacturing process of neodymium-iron-boron magnetic steel, the neodymium-iron-boron fine powder formed by jet milling is directly subjected to fine powder stirring without separation.

Provided is a neodymium-iron-boron powder stirring system which is suitable to the neodymium-iron-boron powder stirring process according to the present application, the neodymium-iron-boron powder stirring system comprises a compressor, a gas storage tank, and a pulse-type pneumatic mixer, wherein:

the compressor is used to transmit pressurized nitrogen and/or inert gas into the gas storage tank;

the gas storage tank is used to store the nitrogen and/or the inert gas; and

one or more nozzles which are connected to the gas storage tank and can be opened and closed at intervals are provided at the bottom of the pulse-type pneumatic mixer, so as to make the neodymium-iron-boron powder accumulated in the pulse-type pneumatic mixer be mixed and stirred under the action of a pulsed gas flow blown from the nozzles.

Preferably, in the above-mentioned neodymium-iron-boron powder stirring system, the nozzles can be opened and closed at intervals, the opening duration is between 0.2 and 0.4 seconds.

Preferably, in the above-mentioned neodymium-iron-boron powder stirring system, after the nitrogen and/or inert gas are pressurized by the compressor, the pressure is between 0.1 MPa and 1 MPa.

Preferably, in the above-mentioned neodymium-iron-boron powder stirring system, a discharge port and a barrel for receiving the neodymium-iron-boron powder are provided at the bottom of the pulse-type pneumatic mixer, and a discharge oxygen exhausting port is provided at the discharge port.

Preferably, in the above-mentioned neodymium-iron-boron powder stirring system, a quantitative pump is externally connected to the bottom of the pulse-type pneumatic mixer.

Preferably, in the above-mentioned neodymium-iron-boron powder stirring system, a main material feeding port and an auxiliary material feeding port are provided at the top of the pulse-type pneumatic mixer, and a feed oxygen exhausting port is provided on the main material feeding port.

Preferably, in the above-mentioned neodymium-iron-boron powder stirring system, a separation filter device is provided at the top outlet of the pulse-type pneumatic mixer, and the separation filter device comprises a cyclone separator provided at the top outlet and a filter connected with a gas outlet of the cyclone separator.

Preferably, in the above-mentioned neodymium-iron-boron powder stirring system, a buffer tank is connected with the gas outlet of the filter and the inlet of the compressor, and the buffer tank is connected to a gas source.

Preferably, in the above-mentioned neodymium-iron-boron powder stirring system, a refrigeration dryer is further provided between the compressor and the gas storage tank.

Preferably, in the above-mentioned neodymium-iron-boron powder stirring system, a first pneumatic shut-off valve and a first check valve are provided between the gas storage tank and the buffer tank, wherein the first check valve allows the gas to flow from the gas storage tank to the buffer tank and blocks the gas in the reverse direction, and when the pressure is greater than the first preset value, the first pneumatic shut-off valve is opened.

Preferably, in the above-mentioned neodymium-iron-boron powder stirring system, a second pneumatic shut-off valve and a second check valve are provided between the outlet of the separation filter device and the buffer tank, wherein the second check valve allows the gas to flow from the separation filter device to the buffer tank, and blocks the gas in the reverse direction, and when the pressure is less than the second preset value, the second pneumatic shut-off valve is closed.

Preferably, in the above-mentioned neodymium-iron-boron powder stirring system, an observation window is provided on the pulse-type pneumatic mixer.

Preferably, in the above-mentioned neodymium-iron-boron powder stirring system, a first oxygen meter and a temperature sensor are provided on the connecting pipe between the gas storage tank and the pulse-type pneumatic mixer.

Preferably, in the above-mentioned neodymium-iron-boron powder stirring system, a second oxygen meter is provided on the buffer tank.

Preferably, in the above-mentioned neodymium-iron-boron powder stirring system, a pressure sensor is connected with the outlet of the compressor.

The neodymium-iron-boron powder stirring system according to the present application is suitable to the neodymium-iron-boron powder stirring process according to the present application. When the neodymium-iron-boron powder stirring system is in operation, after the nozzle is opened, the gas flows out from the nozzle, so that the powder is thrown upwards along with the gas. By controlling the pressure of the gas, the duration for spraying and the time gap between opening and closing of the nozzles, the height at which the powder is sprayed may be controlled, the sprayed powder could be rolled, and the nozzle is closed subsequently so that the powder is falling. The nozzles are opened and closed at intervals and cyclically so that the effect of the powder being stirred and fully mixed could be achieved. The experiment proves that the powder can be mixed evenly by seven cycles (or more) of opening and closing of nozzle. In practical use, in order to ensure the powder of being fully mixed, a ten-minute mixing will meet the requirement. Compared with the three-dimensional mixer, the neodymium-iron-boron powder stirring system has less time consuming with higher working efficiency and sufficient and uniform mixing of powder.

Here, since the amount of gas consuming of the pulsed gas flow in the pulse-type pneumatic mixer is relative high and the pulsed gas flow is intermittently sprayed, a gas storage tank is arranged between the compressor and the pulse-type pneumatic mixer so that the compressor does not need to be shut down and could keep inflating the gas storage tank when the pulsed gas flow is stopped to be sprayed, i.e., the nozzle is closed. In addition, when the pulsed gas flow is sprayed through the nozzles in the pulse-type pneumatic mixer so as to stir and mix the neodymium-iron-boron powder, and the gas flows out of the gas storage tank, which is beneficial to stabilize the spray pressure of the nozzle.

Furthermore, the neodymium-iron-boron powder stirring system according to the present application is a closed circulation system, which could recycle nitrogen and/or inert gas.

### BRIEF DESCRIPTION OF THE DRAWINGS

In order to explain the embodiments of the present invention or the technical solutions in the prior art more clearly, the accompany drawings needed be used in the description to the embodiments or the prior art will be now briefly illustrated. Obviously, the followed drawings only represent some embodiments of the present invention. For those skilled in the art, other drawings could be obtained based on these drawings without creative work.

FIG. 1 is a schematic structural view of a neodymium-iron-boron powder stirring system according to a third embodiment of the present invention;

FIG. 2 is an isometric view of the pulse-type pneumatic mixer according to the third embodiment of the present invention;

FIG. 3 is a front view of a pulse-type pneumatic mixer according to the third embodiment of the present invention;

FIG. 4 is a top view of a pulse-type pneumatic mixer according to the third embodiment of the present invention;

FIG. 5 is a bottom view of the pulse-type pneumatic mixer according to the third embodiment of the present invention.

Among them

1 compressor, 2 refrigeration dryer, 3 gas storage tank, 4 temperature sensor, 5 first oxygen meter, 6 pulse-type pneumatic mixer, 8 buffer tank, 10 pressure sensor, 11 first pneumatic shut-off valve, 12 first check valve, 13 second pneumatic shut-off valve, 14 second check valve,
61 main material feeding port, 62 auxiliary material feeding port, 63 discharge oxygen exhausting port 64 quantitative pump, 65 hexagon bolt, 66 standard 200 port connector, 67 metal hard seal eccentric butterfly valve, 68 manual ball valve, 610 feed oxygen exhausting port, 611 pneumatic piston type A rubber-lined butterfly valve, 620 manual DN50 butterfly valve, 71 dust collector, 72 pneumatic knocking hammer, 73 inlet pipe of a separator, 74 transparent steel wire wound hose, 75 outlet pipe of a separator, 76 separator body, 77 first pneumatic butterfly valve, 78 second pneumatic butterfly valve, 79 filter, 81 second oxygen meter.

### DETAILED DESCRIPTION OF THE EMBODIMENTS

Hereinbelow, embodiments of the present invention will be described in detail and whole with reference to the accompanying drawings. Obviously, the described embodiments can only represent some embodiments of the present invention rather than all. Based on the embodiments of the present invention, any other embodiments obtained by those skilled in the art without creative work should be included within the scope of the invention.

### First Embodiment

The first embodiment according to the present invention provides a neodymium-iron-boron powder stirring process, comprising the following steps:

inflation: filling nitrogen and/or inert gas inside a mixer, with internal space of the mixer being closed;

feeding: feeding neodymium-iron-boron powder to be stirred into the mixer and maintaining the internal space of the mixer closed;

stirring: inflating the mixer with a pulsed gas flow, which is a gas flow sprayed at intervals and formed by nitrogen and/or inert gas, wherein the pulsed gas flow can repeatedly blow up and down the neodymium-iron-boron powder so as to mix and stir the neodymium-iron-boron powder.

It can be seen that in the neodymium-iron-boron powder stirring process of the first embodiment according to the present invention, the powder can be generally fully mixed after about ten minutes of mixing by mixing and stirring the neodymium-iron-boron powder with pulsed gas flow. It is proved by the tests that such neodymium-iron-boron powder stirring process can not only make the powder to be mixed fully and uniformly, but also have a shorter stirring time and higher operation efficiency.

Specifically, in the above-mentioned neodymium-iron-boron powder stirring process, the pulsed gas flow is provided by a nozzle arranged at the bottom of the mixer and a gas transmission pipeline connected with the nozzle.

Specifically, in the above-mentioned neodymium-iron-boron powder stirring process, the continuous spray duration of the pulsed gas flow is between 0.2 and 0.4 seconds, the continuous suspend duration is greater than 1 second; and the spray pressure of the pulsed gas flow is between 0.7 Mpa and 0.8 Mpa (preferably 0.75 Mpa).

Alternatively, in other embodiments, the pulsed gas flow may also be formed by gas flows with alternating high and low pressure. For example, a continuous high-pressure injection is in the duration of 0.2 to 0.4 seconds, and then a continuous low-pressure injection is in the duration of greater than 1 second, thereby forming a pulsed gas flow. Here, the jet pressure of the pulsed gas flow during continuous high-pressure injection is between 0.7 Mpa and 0.8 Mpa, and the gas flow pressure during continuous low-pressure injection is greater than atmospheric pressure but less than 0.7 Mpa.)

Specifically, in the above-mentioned neodymium-iron-boron powder stirring process, the nitrogen and/or inert gas used to form the pulsed gas flow enters the mixer after being cooled. The temperature of the nitrogen and/or inert gas before entering the mixer is between 15° C. and 25° C.

It could be seen that when the neodymium-iron-boron powder is mixed and stirred by pulsed gas flow, the temperature of the neodymium-iron-boron powder could be controlled by controlling the temperature of the gas flow, which is beneficial to avoid performance changes of the neodymium-iron-boron powder being affected by the temperature during the stirring process.

Specifically, in the above-mentioned neodymium-iron-boron powder stirring process, the following steps are further included:

separation and filtration: performing a gas-solid separation to the mixed gas flowing out of the mixer;

circulation: feeding the neodymium-iron-boron powder obtained by separation back to the mixer to continue to be mixed; sending the gas obtained by separation into the mixer to form a pulsed gas flow.

### Second Embodiment

The second embodiment of the present invention provides a manufacturing process of neodymium-iron-boron magnetic steel, comprising the following steps:

smelting: mixing raw materials at a preset ratio and smelting to obtain massive alloy ingots or flake alloy ingots;

hydrogen crushing: feeding the massive alloy ingots or flake alloy ingots into a hydrogen crushing reactor to react with hydrogen to form neodymium-iron-boron coarse powder with larger particles; (larger particles refer that the neodymium-iron-boron coarse powder has larger particles than the neodymium-iron-boron fine powder mentioned below)

coarse powder stirring: feeding the neodymium-iron-boron coarse powder into a first mixer for mixing and stirring;

jet milling: further processing the neodymium-iron-boron coarse powder that has been subjected to coarse powder stirring using jet milling to form neodymium-iron-boron fine powder with smaller particles; (smaller particles refer that the neodymium-iron-boron fine powder has smaller particles than the neodymium-iron-boron coarse powder mentioned above)

fine powder stirring: feeding the neodymium-iron-boron fine powder into a second mixer for mixing and stirring, wherein the stirring process of the second mixer is the stirring process of neodymium-iron-boron powder provided in the first embodiment;

forming: making the neodymium-iron-boron fine powder that has been subjected to fine powder stirring into a block-shaped blank using a press and a mold; and

sintering: sintering the formed block-shaped blank to form neodymium-iron-boron magnetic steel in a sintering furnace.

In addition, in the above-mentioned manufacturing process of neodymium-iron-boron magnetic steel, the stirring process of the first mixer can also apply the neodymium-iron-boron powder stirring process provided in the first embodiment according to the present invention.

Specifically, in the above-mentioned manufacturing process of neodymium-iron-boron magnetic steel, an additive is added to the second mixer during the process of fine powder stirring.

If the additive is a solid additive, the method of adding can be as follows: during the process of the fine powder stirring, the solid additive is added into the second mixer through an auxiliary material feeding port provided on the second mixer, and the solid additive is mixed with the neodymium-iron-boron fine powder.

If the additive is a liquid additive, the method of adding can be as follows: during the process of the fine powder stirring, the liquid additive is spayed into the second mixer after being atomized by the auxiliary material injector provided on the second mixer, and the liquid additive is mixed with the neodymium-iron-boron fine powder

Alternatively, a nozzle for forming a pulsed gas flow is provided at the bottom of the second mixer, which is externally connected with a gas transmission pipeline for transmission of nitrogen and/or inert gas, and when spraying the pulsed gas flow, the liquid additive is added into the gas transmission pipeline, mixed with nitrogen and/or inert gas, and then sprayed into the second mixer through the nozzle.

The experiment has proved that, in the process of fine powder stirring, a better uniformity could be achieved when solid additives or liquid additives are added in accordance with the above methods. However, when three-dimensional mixer is applied to stir the neodymium-iron-boron powder, additives cannot be added gradually during the stirring process, uneven stirring is prone to occur.

Specifically, in the above-mentioned manufacturing process of neodymium-iron-boron magnetic steel, a ultra-fine powder is obtained by separating the neodymium-iron-boron fine powder formed by jet milling through a separator, and the ultra-fine powder is added to the second mixer, and mixed and stirred with the neodymium-iron-boron fine powder, wherein the ultra-fine powder has an average particle size of less than 2 microns.

Alternatively, in the above-mentioned manufacturing process of neodymium-iron-boron magnetic steel, the neodymium-iron-boron fine powder formed by jet milling is directly subjected to fine powder stirring without separation.

### Third Embodiment

The third embodiment of the present invention provides a neodymium-iron-boron powder stirring system, which is suitable for the neodymium-iron-boron stirring process provided in the first embodiment according to the present invention.

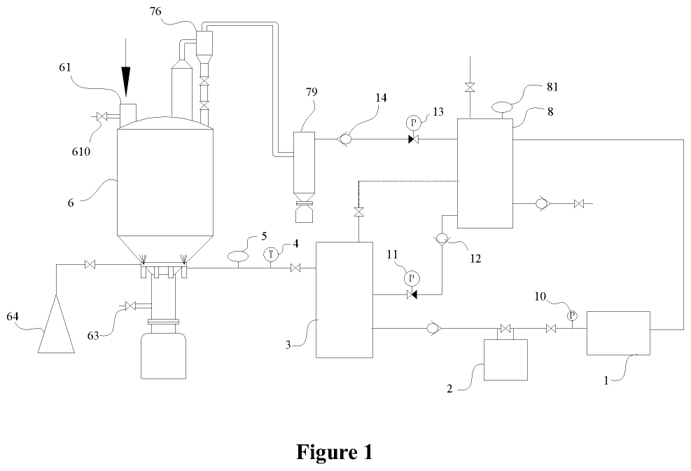

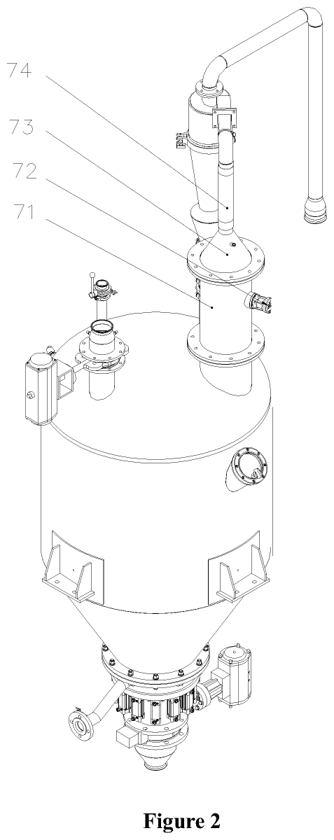

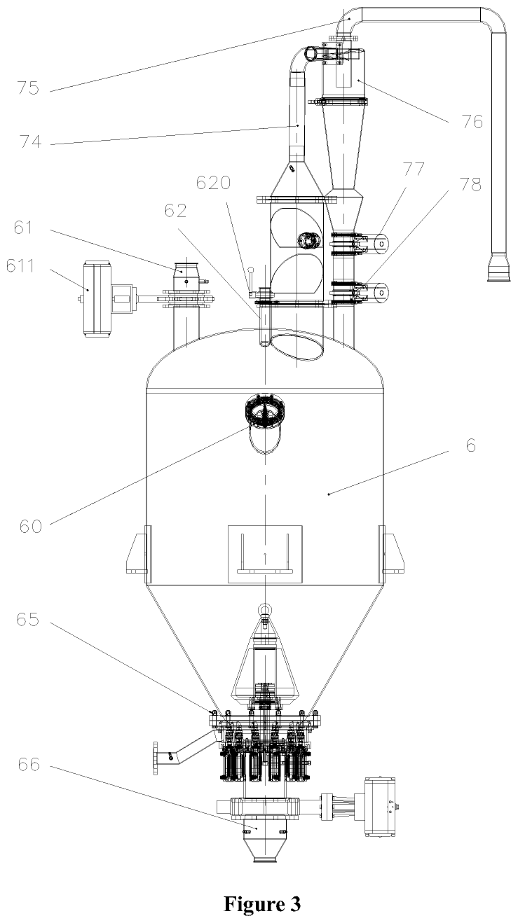

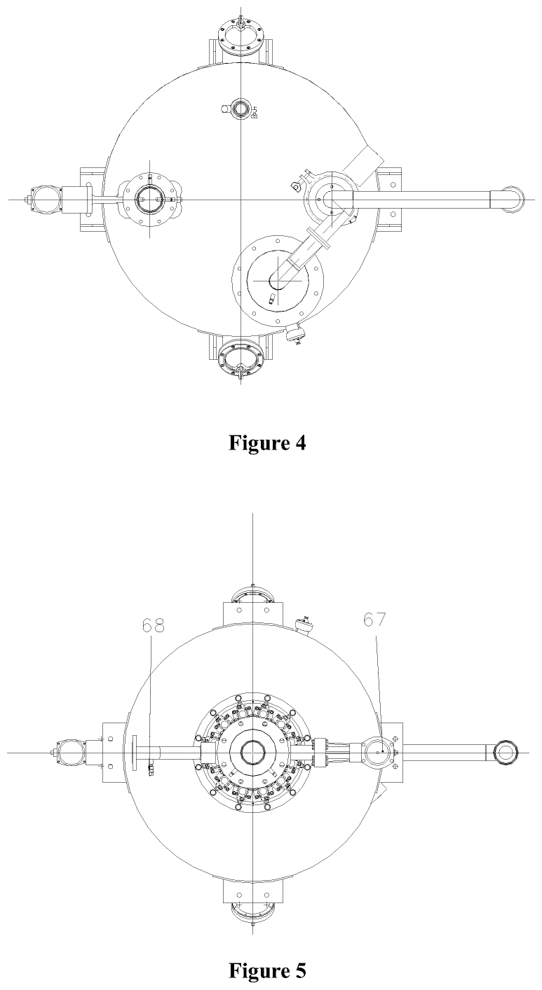

Specifically, please refer to FIGS. 1 to 5. FIG. 1 is a schematic structural view of a neodymium-iron-boron powder stirring system according to the third embodiment of the present invention. FIG. 2 is an isometric view of the pulse-type pneumatic mixer according to the third embodiment of the present invention. FIG. 3 is a front view of a pulse-type pneumatic mixer according to the third embodiment of the present invention. FIG. 4 is a top view of a pulse-type pneumatic mixer according to the third embodiment of the present invention. FIG. 5 is a bottom view of the pulse-type pneumatic mixer according to the third embodiment of the present invention.

The neodymium-iron-boron powder stirring system includes a compressor 1, a gas storage tank 3, and a pulse-type pneumatic mixer 6, in which the compressor 1 is used to transmit pressurized nitrogen or inert gas into the gas storage tank 3 (herein, nitrogen and inert gas are collectively referred to as gas), the gas storage tank 3 is used to store nitrogen and inert gas, and the internal pressure of the gas storage tank 3 is higher than atmospheric pressure (that is, a high-pressure gas is stored so that the nozzles can spray gas flow). One or more nozzles which are connected to the gas storage tank 3 and can be opened and closed at intervals are provided at the bottom of the pulse-type pneumatic mixer 6, so as to make the neodymium-iron-boron powder accumulated in the pulse-type pneumatic mixer 6 be mixed and stirred under the action of a pulsed gas flow blown from the nozzles.

When the neodymium-iron-boron powder stirring system is in operation, after the nozzle is opened, the gas flows out from the nozzle, so that the powder is thrown upwards along with the gas. By controlling the pressure of the gas, the duration for spraying and the time gap between opening and closing of the nozzles, the height at which the powder is sprayed may be controlled, the sprayed powder could be rolled, and the nozzle is closed subsequently so that the powder is falling. The nozzles are opened and closed at intervals and cyclically so that the effect of the powder being stirred and fully mixed could be achieved. The experiment proves that the powder can be mixed evenly by seven cycles (or more) of opening and closing of nozzle. In practical use, in order to ensure the powder of being fully mixed, a ten-minute mixing will meet the requirement. Compared with the three-dimensional mixer, the neodymium-iron-boron powder stirring system has less time consuming with higher working efficiency and sufficient and uniform mixing of powder.

Here, since the amount of gas consuming of the pulsed gas flow in the pulse-type pneumatic mixer 6 is relative high and the pulsed gas flow is intermittently sprayed, a gas storage tank 3 is arranged between the compressor 1 and the pulse-type pneumatic mixer 6 so that the compressor 1 does not need to be shut down and could keep inflating the gas storage tank 3 when the pulsed gas flow is stopped to be sprayed, i.e., the nozzle is closed. In addition, when the pulsed gas flow is sprayed through the nozzles in the pulse-type pneumatic mixer 6 so as to stir and mix the neodymium-iron-boron powder, and the gas flows out of the gas storage tank 3, which is beneficial to stabilize the spray pressure of the nozzle.

Specifically, the purity of the nitrogen and/or inert gas used to form the pulsed gas flow is greater than 99.99%. After the nitrogen and/or inert gas are pressurized by the compressor 1, the pressure is between 0.1 MPa and 1 MPa.

Specifically, if the nozzle opening time (i.e., the gas flow jet duration) is too short, the effect of throwing up the powder will not be achieved, and if said duration is too long, the powder will be thrown up too high, which will affect the separation filter device installed at the outlet of the pulse-type pneumatic mixer 6 and result in too much gas consuming. Therefore, preferably, the nozzles can be opened and closed at intervals, the opening duration is between 0.2 and 0.4 seconds, and the closing duration is preferably between 2 and 5 seconds (or even longer).

Specifically, a discharge port and a barrel for receiving the neodymium-iron-boron powder are provided at the bottom of the pulse-type pneumatic mixer 6. The powder that has been fully stirred and mixed flows out via the discharge port to the barrel for collection.

Specifically, a discharge oxygen exhausting port 63 is provided at the above-mentioned discharge port; and a quantitative pump 64 is externally connected to the bottom of the pulse-type pneumatic mixer 6.

Specifically, a main material feeding port 61 and an auxiliary material feeding port 62 are provided at the top of the pulse-type pneumatic mixer 6, and a feed oxygen exhausting port 610 is provided on the main material feeding port 61. In the process of stirring and mixing the neodymium-iron-boron powder, solid additives or liquid additives (i.e., auxiliary materials) could be added. The solid additive is also in the form of powder and could be directly added through the auxiliary material feeding port 62. The liquid additive could be added to the gas transmission pipeline during gas flow jet, and then mixed with the gas and then sprayed out; or the liquid additive could be sprayed out gradually after being atomized during the process of powder stirring by the auxiliary material injector for feeding the liquid additive (i.e., an auxiliary material nozzle for spraying the liquid additive), which is provided at the auxiliary material feeding port 62. The experiment has proved that a better mixing uniformity could be achieved by the above methods. In contrast, the three-dimensional mixer cannot gradually feed additives during the stirring process, and uneven stirring is prone to occur.

Here, the feeding amount of auxiliary materials is about 0.05% of the main materials. The main material feeding port 61 preferably has a diameter of DN 200 unit mm. “DN” refers to the nominal diameter of the pipeline, which is neither the outer diameter nor the inner diameter. It is the mean value of the outer diameter and the inner diameter, which is called the average inner diameter.

In order to further optimize the above technical solution, as shown in FIGS. 1 to 3, in the neodymium-iron-boron powder stirring system according to embodiments of the present invention, a cyclone separator is provided on the top of the pulse-type pneumatic mixer 6. The cyclone separator includes a dust collector 71, an inlet pipe of a separator 73, a transparent steel wire wound hose 74, a separator body 76, a first pneumatic butterfly valve 77, and a second pneumatic butterfly valve 78, which are connected in sequence. Here, a pneumatic knocking hammer 72 is provided at the outside of the dust collector 71, an inlet in the bottom of the dust collector 71 is the inlet for mixed gas entrained with powder, which is connected with the top outlet of the pulse-type pneumatic mixer 6, an outlet of the pipeline connected with the second pneumatic butterfly valve 78 is output port for recycling powder, which is connected to the recycling inlet at the top of the pulse-type pneumatic mixer 6 (or extends inside the pulse-type pneumatic mixer 6).

Further, the gas outlet of the separator body 76 is also connected to a filter 79 via an outlet pipe of a separator 75, the inlet of the filter 79 is connected to the gas outlet of the separator body 76, and a receiving barrel of filter is provided at the material discharge port of the filter 79, which is used to collect the filtered powder. Here, the filtration accuracy of the filter 79 is less than 1.5 micrometers, and preferably 1 micrometer.

During the process of mixing the powder by spraying gas with the nozzle, the first pneumatic butterfly valve 77 is opened and the second pneumatic butterfly valve 78 is closed. The gas flow first passes through the cyclone separator to separate a large part of the powder carried while a small part of the unseparated powder accompanies with the gas flow and enters the filter 79 to be filtered (the filtered gas enters the buffer tank 8, and the filtered powder is collected in the receiving barrel of filter).

When the gas flow stops, that is, after the mixing is ending, the first pneumatic butterfly valve 77 is closed, and the second pneumatic butterfly valve 78 is opened, and thus the filtered powder will fall back into the pulse-type pneumatic mixer 6, which is beneficial of ensuring the life span of the filter 79.

In the above-mentioned neodymium-iron-boron powder stirring system, the gas used for mixing the neodymium-iron-boron powder is nitrogen and/or inert gas, which is relatively expensive, and thus needs to be reutilized. Therefore, in order to further optimize the above technical solution, the neodymium-iron-boron powder stirring system is configured as a closed circulation system.

Specifically, as shown in FIG. 1, a buffer tank 8 is connected with the gas outlet of the filter 79 and the inlet of the compressor 1. In addition, the buffer tank 8 is connected to a gas source (i.e., nitrogen or inert gas coming from the plant). The buffer tank 8 has a slight positive pressure inside.

In operation, the gas is compressed by the compressor and then transmitted to the pulse-type pneumatic mixer 6 at which the multi-powder materials are mixed. The gas after participating in the stirring passes through the separation filter device to remove the powder in the gas, and then passes through the pipeline and the buffer tank 8 to return back to the inlet of the compressor 1 for recycling, so as to ensure that the gas will not be discharged into the atmosphere, that is, the neodymium-iron-boron powder stirring system is a closed circulation system.

Moreover, in the above-mentioned neodymium-iron-boron powder stirring system, a buffer tank 8 is provided between the pulse-type pneumatic mixer 6 and the compressor 1 so that a large amount of gas may be stored in the buffer tank 8 during the stirring and mixing process that the powder is sprayed by pulsed gas flow in the pulse-type pneumatic mixer 6, so as to avoid accumulation of excessive gas in the pulse-type pneumatic mixer 6 due to the limited flowing capacity of the compressor during the spraying process.

Here, the separation filter device is used to separate and filter the gas and powder flowing out of the top outlet of the pulse-type pneumatic mixer 6 so as to ensure that there are no solid particles in the gas returning to the compressor.

In summary, in the above-mentioned neodymium-iron-boron powder stirring system, the nitrogen and/or inert gas from the plant area are first transmitted to the buffer tank 8 and then into the compressor 1, the gas compressed by the compressor 1 is first stored in the gas storage tank 3, and then transferred to the nozzle at the pulse-type pneumatic mixer 6, to form pulsed gas flow through the nozzle to stir and mix the neodymium-iron-boron powder accumulated in the pulse-type pneumatic mixer 6. Next, after the mixed gas from the pulse-type pneumatic mixer 6 is filtered by the separation filter device, the powder separated from the mixed gas is returned back to the pulse-type pneumatic mixer 6 to participate in the stirring process of the remaining powder, and the separated gas (nitrogen and/or inert gas) is transmitted to the buffer tank 8 to be stored temporarily, and then enter the compressor 1 for recycling.

Specifically, in the above-mentioned neodymium-iron-boron powder stirring system, a refrigeration dryer 2 is also provided between the compressor 1 and the gas storage tank 3. During the production process, as the gas expands when it is sprayed though the nozzle, resulting in a cooling effect, and in addition with the cooling effect of the refrigeration dryer 2, the temperature in the pulse-type pneumatic mixer 6 could be well controlled to avoid the oxidation of the powder. The experiment has proved that the temperature could be controlled at 0-20° C. during mixing.

Specifically, in the above-mentioned neodymium-iron-boron powder stirring system, a first pneumatic shut-off valve 11 and a first check valve 12 are provided between the gas storage tank 3 and the buffer tank 8, wherein the first check valve 12 allows the gas to flow from the gas storage tank 3 to the buffer tank 8 and blocks the gas in the reverse direction. When the pressure is greater than the first preset value, the first pneumatic shut-off valve 11 is opened (that is, opened under high pressure).

Specifically, in the above-mentioned neodymium-iron-boron powder stirring system, a second pneumatic shut-off valve 13 and a second check valve 14 are provided between the outlet of the separation filter device and the buffer tank 8, wherein the second check valve 14 allows the gas to flow from the separation filter device to the buffer tank 8, and blocks the gas in the reverse direction. When the pressure is less than the second preset value, the second pneumatic shut-off valve 13 is closed (that is, closed under low pressure).

Specifically, in the above-mentioned neodymium-iron-boron powder stirring system, an observation window 60 is provided on the pulse-type pneumatic mixer 6.

Specifically, in the above-mentioned neodymium-iron-boron powder stirring system, a first oxygen meter 5 and a temperature sensor 4 are provided on the connecting pipe between the gas storage tank 3 and the pulse-type pneumatic mixer 6, the temperature sensor 4 is used for detecting whether the gas temperature in the pipeline is within the range of 20±5° C.

Specifically, a pressure sensor 10 is connected with the outlet of the compressor 1 and the pressure sensor 10 is used for detecting whether the gas pressure in the pipeline is greater than 0.75 Mpa.

Specifically, a third check valve is provided between the refrigeration dryer 2 and the gas storage tank 3 to allow gas to flow from the refrigeration dryer 2 into the gas storage tank 3 and block the gas in the reverse direction.

Specifically, a fourth check valve is provided at the inlet of the buffer tank 8 connected to the gas source, which is used to allow gas to enter the buffer tank 8 and block the gas in the reverse direction. A second oxygen meter 81 is provided on the buffer tank 8.

Specifically, the technical requirement of the neodymium-iron-boron powder stirring system according to the embodiment of the present invention is given below:

(1) Material bulk density (i.e., the density of the pile of neodymium-iron-boron powder accumulated in the pulse-type pneumatic mixer 6): 1 to 3t/m³, actual specific gravity: 7t/m³;

(2) Average particle size of the materials: 3 um;

(3) Particle size of additive (i.e., auxiliary material): 200 to 300 mesh, bulk density: 1t/m³;

(4) Single batch mixing volume: 1200 kg;

(5) The full volume of the pulse-type pneumatic mixer: 1.6 m³;

(6) Residue in equipment: <10 g<100 kg.

In addition, in the neodymium-iron-boron production process, a certain quantity of ultra-fine powders with an average particle size of less than 2 microns may be produced in the jet milling operation previous to the powder milling. As these ultra-fine powders are easily oxidized, they are generally separated by a separator during the jet milling, and then are incinerated or treated in other means, and cannot be used for the normal production. However, when the neodymium-iron-boron powder stirring system according to the embodiment of the present invention is used, since the powder obtained by stirring and mixing is more uniform, and the ambient temperature when stirring and mixing the powder could be controlled, the ultra-fine powder could be added into the pulse-type pneumatic mixer 6 for stirring and mixing, or the ultra-fine powder is not separated in the previous jet milling operation, thereby reducing the waste of materials and simplifying the process.

Finally, it should be noted that in the present disclosure, the relational terms such as “first” and “second” are only used to distinguish one entity or operation from another entity or operation, and do not necessarily limit or imply the entity or operation to be with some certain relation or sequence. Moreover, the terms “comprise”, “include” or any other variants thereof are intended to cover non-exclusive inclusion so that a process, method, article or device including a series of elements not only includes those elements, but also includes those that are not recited herein, or also include elements inherent to this process, method, article or equipment. Provided there is no further limitation, the element defined by the expression “comprising a . . . ” does not exclude the existence of other identical elements in the process, method, article, or equipment that includes the same.

The various embodiments in this specification are described in a progressive manner. Each embodiment focuses on the differences from other embodiments, and the same or similar parts between the various embodiments could be referred to each other.

The foregoing description of the disclosed embodiments enables those skilled in the art to implement or use the present invention. Various modifications to these embodiments will be obvious to those skilled in the art, and the general principles defined herein can be implemented in other embodiments without departing from the spirit or scope of the present invention. Therefore, the present invention will not be limited to the embodiments shown in this document, but should conform to the widest scope consistent with the principles and novel features disclosed in this document.

1. A stirring process of neodymium-iron-boron powder, comprising the following steps:
inflation: filling nitrogen and/or inert gas inside a mixer, with internal space of the mixer being closed;
feeding: feeding neodymium-iron-boron powder to be stirred into the mixer and maintaining the internal space of the mixer closed;
stirring: inflating the mixer with a pulsed gas flow, which is a gas flow sprayed at intervals and formed by nitrogen and/or inert gas, wherein the pulsed gas flow can repeatedly blow up and down the neodymium-iron-boron powder so as to mix and stir the neodymium-iron-boron powder.

2. The stirring process of neodymium-iron-boron powder according to claim 1, wherein the pulsed gas flow is provided by a nozzle arranged at the bottom of the mixer and a gas transmission pipeline connected with the nozzle.

3. The stirring process of neodymium-iron-boron powder according to claim 2, wherein a continuous spray duration of the pulsed gas flow is between 0.2 and 0.4 seconds, a continuous suspend duration is greater than 1 second, and a spray pressure of the pulsed gas flow is between 0.7 Mpa and 0.8 Mpa.

4. The stirring process of neodymium-iron-boron powder according to claim 1, wherein the nitrogen and/or inert gas used to form the pulsed gas flow enter the mixer after being cooled, a temperature of the nitrogen and/or inert gas before entering the mixer is between 15° C. and 25° C.

5. The stirring process of neodymium-iron-boron powder according to claim 1, wherein the process further comprises the following steps:
separation and filtration: performing a gas-solid separation to the mixed gas flowing out of the mixer;
circulation: feeding the neodymium-iron-boron powder obtained by separation back to the mixer to continue to be mixed; sending the gas obtained by separation into the mixer to form a pulsed gas flow.

6. A manufacturing process of neodymium-iron-boron magnetic steel, comprising the following steps:
smelting: mixing raw materials at a preset ratio and smelting to obtain massive alloy ingots or flake alloy ingots;
hydrogen crushing: feeding the massive alloy ingots or flake alloy ingots into a hydrogen crushing reactor to react with hydrogen to form neodymium-iron-boron coarse powder with larger particles;
coarse powder stirring: feeding the neodymium-iron-boron coarse powder into a first mixer for mixing and stirring;
jet milling: further processing the neodymium-iron-boron coarse powder that has been subjected to coarse powder stirring using jet milling to form neodymium-iron-boron fine powder with smaller particles;
fine powder stirring: feeding the neodymium-iron-boron fine powder into a second mixer for mixing and stirring, wherein the stirring process of the second mixer is the stirring process of neodymium-iron-boron powder according to claim 1;
forming: making the neodymium-iron-boron fine powder that has been subjected to fine powder stirring into a block-shaped blank using a press and a mold; and
sintering: sintering the formed block-shaped blank to form neodymium-iron-boron magnetic steel in a sintering furnace.

7. The manufacturing process of neodymium-iron-boron magnetic steel according to claim 6, wherein an additive is added to the second mixer during the process of fine powder stirring.

8. The manufacturing process of neodymium-iron-boron magnetic steel according to claim 7, wherein the additive is a solid additive, and during the process of the fine powder stirring, the solid additive is added into the second mixer through an auxiliary material feeding port provided on the second mixer, and the solid additive is mixed with the neodymium-iron-boron fine powder.

9. The manufacturing process of neodymium-iron-boron magnetic steel according to claim 7, wherein the additive is a liquid additive, and during the process of the fine powder stirring, the liquid additive is spayed into the second mixer after being atomized by the auxiliary material injector provided on the second mixer, and the liquid additive is mixed with the neodymium-iron-boron fine powder.

10. The manufacturing process of neodymium-iron-boron magnetic steel according to claim 7, wherein the additive is a liquid additive,
a nozzle for forming a pulsed gas flow is provided at the bottom of the second mixer, which is externally connected with a gas transmission pipeline for transmission of nitrogen and/or inert gas, and
when spraying the pulsed gas flow, the liquid additive is added into the gas transmission pipeline, mixed with nitrogen and/or inert gas, and then sprayed into the second mixer through the nozzle.

11. The manufacturing process of neodymium-iron-boron magnetic steel according to claim 6, wherein an ultra-fine powder is obtained by separating the neodymium-iron-boron fine powder formed by jet milling through a separator, and the ultra-fine powder is added to the second mixer, and mixed and stirred with the neodymium-iron-boron fine powder, wherein the ultra-fine powder has an average particle size of less than 2 microns.

12. The manufacturing process of neodymium-iron-boron magnetic steel according to claim 6, wherein the neodymium-iron-boron fine powder formed by jet milling is directly subjected to fine powder stirring without separation.

13. A neodymium-iron-boron powder stirring system, comprising a compressor (1), a gas storage tank (3), and a pulse-type pneumatic mixer (6), wherein:
the compressor (1) is used to transmit pressurized nitrogen and/or inert gas into the gas storage tank (3);
the gas storage tank (3) is used to store the nitrogen and/or the inert gas; and
one or more nozzles which are connected to the gas storage tank (3) and can be opened and closed at intervals are provided at the bottom of the pulse-type pneumatic mixer (6), so as to make the neodymium-iron-boron powder accumulated in the pulse-type pneumatic mixer (6) to be mixed and stirred under the action of a pulsed gas flow blown from the nozzles.

14. The neodymium-iron-boron powder stirring system according to claim 13, wherein the nozzles can be opened and closed at intervals, the opening duration is between 0.2 and 0.4 seconds; and/or
after the nitrogen and/or inert gas are pressurized by the compressor (1), the pressure is between 0.1 MPa and 1 MPa; and/or
a discharge port and a barrel for receiving the neodymium-iron-boron powder are provided at the bottom of the pulse-type pneumatic mixer (6), and a discharge oxygen exhausting port (63) is provided at the discharge port; and/or
a quantitative pump (64) is externally connected to the bottom of the pulse-type pneumatic mixer (6); and/or
a main material feeding port (61) and an auxiliary material feeding port (62) are provided at the top of the pulse-type pneumatic mixer (6), and a feed oxygen exhausting port (610) is provided on the main material feeding port (61).

15. The neodymium-iron-boron powder stirring system according to claim 13, wherein a separation filter device is provided at the top outlet of the pulse-type pneumatic mixer (6), and the separation filter device comprises a cyclone separator provided at the top outlet and a filter (79) connected with a gas outlet of the cyclone separator.

16. The neodymium-iron-boron powder stirring system according to claim 15, wherein a buffer tank (8) is connected with the gas outlet of the filter (79) and the inlet of the compressor (1), and the buffer tank (8) is connected to a gas source.

17. The neodymium-iron-boron powder stirring system according to claim 16, wherein a first pneumatic shut-off valve (11) and a first check valve (12) are provided between the gas storage tank (3) and the buffer tank (8), wherein the first check valve (12) allows the gas to flow from the gas storage tank (3) to the buffer tank (8) and blocks the gas in the reverse direction, and when the pressure is greater than the first preset value, the first pneumatic shut-off valve (11) is opened.

18. The neodymium-iron-boron powder stirring system according to claim 16, wherein a second pneumatic shut-off valve (13) and a second check valve (14) are provided between the outlet of the separation filter device (7) and the buffer tank (8), wherein the second check valve (14) allows the gas to flow from the separation filter device (7) to the buffer tank (8), and blocks the gas in the reverse direction, and when the pressure is less than the second preset value, the second pneumatic shut-off valve (13) is closed.

19. The neodymium-iron-boron powder stirring system according to claim 16, wherein a refrigeration dryer (2) is further provided between the compressor (1) and the gas storage tank (3).

20. The neodymium-iron-boron powder stirring system according to claim 19, wherein an observation window (60) is provided on the pulse-type pneumatic mixer (6); and/or
a first oxygen meter (5) and a temperature sensor (4) are provided on the connecting pipe between the gas storage tank (3) and the pulse-type pneumatic mixer (6); and/or
a second oxygen meter (81) is provided on the buffer tank (8); and/or
a pressure sensor (10) is connected with the outlet of the compressor (1).
